(19) United States
(12) Patent Application Publication
(10) Pub. No.: US 2026/0238680 A1
(43) Pub. Date: Aug. 13, 2026

(54) SECURE TRANSMISSION

(71) Applicant: OXFORD UNIVERSITY INNOVATION LIMITED, Oxford (GB)

(72) Inventors: Christopher John STEVENS, Oxford (Oxfordshire) (GB); Ben ALLEN, Oxford (Oxfordshire) (GB); Anthony Keith BROWN, Oxford (Oxfordshire) (GB)

(21) Appl. No.: 19/471,395

(22) PCT Filed: Mar. 28, 2024
(86) PCT No.: PCT/GB2024/050893

§ 371 Date: Oct. 1, 2025

(30) Foreign Application Priority Data
Apr. 3, 2023 (GB) 2304929.9

(51) Int. Cl. H04L 9/40; H04B 10/079; H04L 9/08

(52) U.S. Cl. CPC H04L 63/1475; H04B 10/07953; H04L 9/0869

(57) ABSTRACT

A method of monitoring a transmission includes obtaining one or more values of bit error rate (BER) of the transmission received at a receiver; and determining that the transmission has been intercepted based on a deviation of the obtained bit error rate value from an expected bit error rate value.

### BACKGROUND

Secure communications is seen as an essential for future personal and commercial communication systems, particularly in light of continued increases in sophistication and frequency of cyber attacks and the prospect of quantum computers becoming able to decrypt current encryption schemes in near-real time. Quantum key distribution (QKD) has been of increasing interest to provide such secure systems. The critical benefit of these various methods is the ability, for a pair of terminals, i.e. the transmitter (Tx) and receiver (Rx), to detect the presence and interference by an eavesdropper seeking to eavesdrop on the key being shared between the Tx and Rx. By exploiting the nature of quantum measurements, these schemes enable the detection of the eavesdropper before they can obtain any useful key information. The original suggested scheme used single quanta as the medium of data exchange, which is difficult to realise in a real system because it requires the ability to detect a single energy quanta without ambiguity, i.e. to be able to distinguish between the single wanted quanta rather than that of noise at the same frequency and with the same polarisation. This requires specialist equipment operating at very low temperatures and will be subject to occasional noise quanta being indistinguishable from the wanted quanta. Those demonstrations that have been successful have made use of optical and near infra-red photons to carry the information from the Tx to the Rx, often with polarisation as the coding scheme. This task is made even more difficult if one attempts to create a free-space link (as opposed to a link via optical fibres for instance). Stray light and high link attenuation accrued over longer link distances renders secure key exchange as impossible when using the BB84 protocol. Using multiple photons is proposed to overcome the link losses and detection issues, which makes it vulnerable to eavesdropping, with decoy states being proposed to mitigate this vulnerability. This means varying the light intensity in a random manner hence emitting multiple photons thus the link can no longer be referred to as a quantum link in the strict sense. Continuous Variable QKD or CV-QKD, as opposed to Discrete Variable QKD or DV-QKD described above, has also been proposed. In contrast to DV-QKD, which encodes the polarisation state of a single photon, CV-QKD encodes by means of Gaussian modulation and quadrature signal states and only requires standard optical transmission technologies and homodyne detection.

The use of millimetre wave photons as the quanta of exchange has been considered to overcome some of the limitations of free space optical systems, but unambiguous detection of even 100 GHz photons is a difficult task requiring cryogenic temperature receivers. The impact of thermal background noise on such systems is significant and makes detection of the quanta challenging.

If one examines the main elements of a quantum key distribution system there are three main components.
1. The transmitter and receiver that can emit and detect single quanta.
2. The coding which, is achieved by adjusting a property of the transmitted quanta—for instance their polarisation as introduced in the original BB84 scheme.
3. A conventional public channel which is used to exchange information about the link in order to both enable the establishment of a common encryption key and determine if there is an eavesdropper present.

The presence of the public information channel provides the means by which the Rx tells the Tx the results of the data reception and permit the Rx to identify if eavesdropping has taken place. Because of the fundamental nature of quantum information it is impossible to interfere with the link without evidence being present in the reception of the data.

### BRIEF SUMMARY

In one aspect, a method of monitoring a transmission includes obtaining one or more values of bit error rate (BER) of the transmission received at a receiver, and determining that the transmission has been intercepted based on a deviation of the obtained bit error rate value from an expected bit error rate value.

The method may also include where the expected BER corresponds with the transmission having a first signal to noise ratio (SNR) at the receiver, where a critical value, SNR_{crit}, is a SNR value at a minimum in d(BER)/d(SNR), where BER is the bit error rate at the receiver, and a difference between the first SNR and SNR_{crit} is less than a full width at half maximum of d(BER)/d(SNR) with SNR.

The method may also include at least one of (i) determining the critical value, SNR_{crit}, (ii) determining a SNR corresponding with a negative peak in d(BER)/d(SNR), and (iii) determining an upper SNR value, such that a difference between the upper SNR value and the critical value is less than or equal to the full width at half maximum, and the first SNR is set to be less than the upper SNR value.

The method may also include where the transmission is to have the expected BER at the receiver when a power of the signal at the receiver is: at least 40% of the power of the transmission, or at least 50% of the power of the transmission, or at least 60% of the power of the transmission.

The method may also include where the transmission is encoded using one of Forward Error Correction (FEC), Low Density Parity Check (LDPC) codes, Bose-Chaudhuri-Hocquenghem (BCH) codes, Polar codes, Turbo codes, or Reed Solomon codes.

The method may also include where the transmission is via a point-to-point link, a microwave beam, a beamformed radio link, a line of sight radio link, an optical beam, a laser, an acoustic link, near-field communication, a wired link, a waveguide, or an optical fibre.

The method may also include where the transmission includes one or more pseudorandom sequence (PRS) selected from a set of two pseudorandom sequences, each pseudorandom sequence of the set of pseudorandom sequences representing a message bit.

In some embodiments, the two pseudorandom sequences are not mutually orthogonal.

Each pseudorandom sequence may include a plurality of chips, each chip being a binary digit, and the BER may be determined by determining which pseudorandom sequence of the set is most similar to the pseudorandom sequence as received at the receiver and performing a chip-wise comparison between the pseudorandom sequence as received and the determined pseudorandom sequence of the set.

The method may also include where the transmission carries data indicative of an encryption key.

The method may further comprise determining that a pseudorandom sequence update condition has been met and, in response, updating the set of pseudorandom sequences.

In an aspect, a program for a computer includes instructions that when executed by a computing device, cause the computing device to carry out the method.

In an aspect, a non-transitory computer-readable storage medium includes instructions that when executed by a computing device, cause the computing device to carry out the method.

In an aspect, a computing apparatus includes a processor, and a memory storing instructions that, when executed by the processor, configure the apparatus to carry out the method.

In an aspect, a detection device for use in detecting interception of a transmission includes means to carry out the method, and means to indicate that interception of the transmission has been detected.

Other technical features may be readily apparent to one skilled in the art from the following figures, descriptions, and claims.

In one aspect, a method for transmitting a transmission to a receiver includes setting a parameter of the transmission such that the transmission is to have a first signal to noise ratio (SNR) at the receiver, and causing the transmission to be transmitted according to the set parameter, where a critical value, SNR_{crit}, is a SNR value at a minimum in d(BER)/d(SNR) with SNR, where BER is the bit error rate at the receiver, and a difference between the first SNR and a critical value is less than a full width at half maximum of d(BER)/d(SNR) with SNR.

The method may also include where the method further includes at least one of (i) determining the critical value, SNR_{crit}, (ii) determining a SNR corresponding with a negative peak in d(BER)/d(SNR), and (iii) determining an upper SNR value, such that a difference between the upper SNR value and the critical value is less than or equal to the full width at half maximum, and the parameter is set such that the first SNR is less than the upper SNR value.

The method may also include where the parameter of the transmission is such that the transmission is to have the first signal to noise ratio at the receiver when a power of the signal at the receiver is: at least 40% of the power of the transmission, or at least 50% of the power of the transmission, or at least 60% of the power of the transmission.

The method may include obtaining one or more values of bit error rate (BER) of the signal received at the receiver; and determining that the transmission has been intercepted based on a deviation of the obtained BER values from expected BER values.

The method may also include where the transmission is encoded using one of Forward Error Correction (FEC), Low Density Parity Check (LDPC) codes, Bose-Chaudhuri-Hocquenghem (BCH) codes, Polar codes, Turbo codes, or Reed Solomon codes.

The method may also include where the transmission is via a point-to-point link, a microwave beam, a beamformed radio link, a line of sight radio link, an optical beam, a laser, an acoustic link, near-field communication, a wired link, a waveguide, or an optical fibre.

The method may also include where the transmission includes one or more pseudorandom sequence (PRS) selected from a set of two pseudorandom sequences, each pseudorandom sequence of the set of pseudorandom sequences representing a message bit.

In some examples the two pseudorandom sequences are not mutually orthogonal.

Each pseudorandom sequence may include a plurality of chips, each chip being a binary digit, and the BER may be determined by determining which pseudorandom sequence of the set is most similar to the pseudorandom sequence as received at the receiver and performing a chip-wise comparison between the pseudorandom sequence as received and the determined pseudorandom sequence of the set.

The method may also include where the transmission carries data indicative of an encryption key.

The method may further comprise determining that a pseudorandom sequence update condition has been met and, in response, updating the set of pseudorandom sequences.

In an aspect, a program for a computer includes instructions that when executed by a computing device, cause the computing device to carry out the method.

In an aspect, a non-transitory computer-readable storage medium includes instructions that when executed by a computing device, cause the computing device to carry out the method.

In an aspect, a computing apparatus includes a processor, and a memory storing instructions that, when executed by the processor, configure the apparatus to carry out the method.

In an aspect, a transmitter includes means to carry out the method, and data transmission means to transmit the transmission.

In an aspect, a detection device for use in detecting interception of a transmission includes means to carry out the method, and means to indicate that interception of the transmission has been detected.

In an aspect, a data transmission system includes the transmitter may also include and the detection device.

The data transmission system may also include where the detection device is (i) included in the transmitter, (ii) included in the receiver, or (iii) external to each of the transmitted and the receiver.

Other technical features may be readily apparent to one skilled in the art from the following figures, descriptions, and claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A shows an example of interception of a transmission in a system.

FIG. 1B shows another interception scenario.

FIG. 2 shows the bit error rate for Quadrature Phase Shift Keyed (QPSK) modulated signals having different modulation schemes.

FIG. 3 shows the respective gradients of the BER curves of FIG. 2.

FIG. 4 shows the error probability distribution for different SNR operating points.

FIG. 5A shows the cumulative probability of chip errors in a normal channel of an embodiment and channels subject to amplifier attacks.

FIG. 5B shows the probability of chip errors in a normal channel of an embodiment and channels subject to amplifier attacks.

FIG. 6A shows the cumulative probability of chip errors in a normal channel of an embodiment and a channel subject to a regenerative attack.

FIG. 6B shows the probability of chip errors in a normal channel of an embodiment and a channel subject to a regenerative attack.

FIG. 7A shows the beam pattern for an example transmission.

FIG. 7B shows the beam pattern for another example transmission.

FIG. 8A shows the cumulative probability of chip errors in a normal channel of an embodiment and the cumulative probability of chip errors experienced by a stand-off attacker.

FIG. 8B shows the probability of chip errors in a normal channel of an embodiment and the probability of chip errors experienced by a stand-off attacker.

FIG. 9 shows the overlap 902 between error probability plots for received signals, in normal links and in links under attack.

FIG. 10 illustrates a method of monitoring a transmission in accordance with an embodiment.

FIG. 11 illustrates a device suitable for performing the method of FIG. 11 in accordance with an embodiment.

FIG. 12 illustrates a method for transmitting a transmission to a receiver in accordance with an embodiment.

FIG. 13 illustrates a device suitable for performing the method of FIG. 12 in accordance with an embodiment.

FIG. 14 illustrates another device suitable for performing the method of FIG. 12 in accordance with an embodiment.

FIG. 15 illustrates a system in accordance with an embodiment.

FIG. 16 illustrates a system in accordance with an embodiment.

FIG. 17 illustrates a system in accordance with an embodiment.

FIG. 18 illustrates an aspect of the subject matter in accordance with one embodiment.

FIG. 19 illustrates an aspect of the subject matter in accordance with one embodiment.

FIG. 20 illustrates an example in accordance with one embodiment.

### DETAILED DESCRIPTION

Embodiments disclosed herein relate to systems to detect the presence of an eavesdropper on a channel, and that can be implemented without invoking quantum level measurements, thereby avoiding some of the difficulties associated with quantum level measurements. Embodiments are arranged to reliably detect the presence of an eavesdropper before the eavesdropper can obtain any useful information (such as information about a key transmitted over the channel). Hence, described embodiments may be applied to similar applications as QKD.

Communication links using classical methods are limited by the signal-to-noise ratio (SNR) for a given level of error performance. The present inventors have found that at a critical value of this ratio the rate of incorrect bit transmission can change very quickly with a small change in SNR. The rapid change in bit error rate allows the BER itself to be used as a method for detecting any attempts to intercept transmission. Creating a link in which the SNR is close to the point of maximum BER slope enables very sensitive detection of signal eavesdropping. A shared encryption key, for example, may be transmitted across such a link using a pair of pseudorandom sequences with which to encode the encryption key data without concern that it may be intercepted without detection. According to examples herein, fundamental communications theory (SNR requirements as expressed in Shannon's channel capacity theorem) prevents a simple eavesdropper from successfully intercepting the signals, and also allows detection of the eavesdropping attempt. The approach described herein, whilst described here in terms of radio links, would be equally applicable to optical links, for example, as they are also subject to the same limits.

### Interception Scenarios

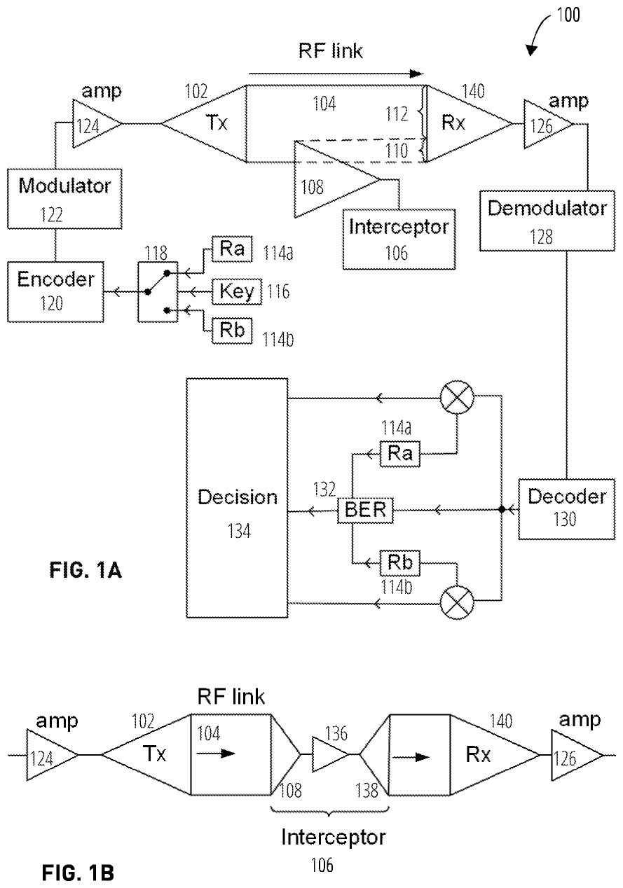

FIG. 1A shows an example of interception of a transmission 104 in a system 100. In the example of FIG. 1A, the transmission 104 is a point-to-point RF link, but other transmission types are also compatible with the concepts described herein. In this example, it is assumed that a key 116 (e.g. an encryption key) is to be transmitted via transmission 104, but other data could be transmitted instead of a key 116.

The link of FIG. 1A is between a transmitter Tx 102 and receiver 140. An interceptor 106, also referred to herein as an attacker or eavesdropper, intercepts a portion of the transmission 104 using interceptor receiver 108. As a result, a portion 112 of transmission 104 is received at receiver 140, while portion 110 of the transmission 104 is received by the interceptor 106 and prevented from reaching receiver 140.

The example of FIG. 1A shows a simple point-to-point radio link, e.g. implemented using horn antennas and lenses. Dishes or other high gain antennas would also suffice. Such links find use, for example, in mobile base station backhaul radio links, high data rate connections where cables cannot be laid and interbuilding or inter-campus data links. Such links are important for achieving connectivity in many wide area networks. However, these conventional networks do not currently have inherent eavesdropping detection capability, making them unsuitable for carrying encryption keys.

Other transmission types are also consistent with examples herein. For example, the transmission 104 may be via a point-to-point link, a microwave beam, a beamformed radio link, a line of sight radio link, an optical beam, a laser, an acoustic link, near-field communication, a wired link, a waveguide, or an optical fibre.

The transmission side of the system shown in FIG. 1A includes a pseudorandom number generator to produce a pair of pseudorandom codes, or pseudorandom sequences (PRS), Ra 114a and Rb 114b. Each of Ra 114a and Rb 114b may be a bit string of a particular length, N_{c}. Each Ra 114a or Rb 114b may represent a single bit in the key 116 to be transmitted via transmission 104. The bits of the key may be referred to herein as key bits. For example, Ra 114a may represent a key bit with value “0” and Rb 114b may represent a key bit with value “1”. Herein, each of the bits of the pseudorandom sequences may be referred to as chips, when distinguishing between the bits (chips) making up the pseudorandom sequences and the bits making up the key 116. Thus, each bit of the key may be represented by Ne chips.

Selector 118 receives pseudorandom sequences Ra 114a and Rb 114b, and key 116 and outputs a string of chips representing key 116. For example, for each bit of key 116 in sequence, selector 118 may output the chips of either Ra 114a or Rb 114b, depending on whether the current bit of key 116 is a “0” or a “1”.

The chip string produced by the selector 118 is encoded by encoder 120. For example, a Low Density Parity Check (LDPC) scheme, or some other Error Correction Code (ECC), may be applied to the chip string. The output of the encoder may then be modulated by modulator 122. For example, Quadrature Phase Shift Keyed (QPSK) may be employed to modulate the signal. The modulated signal may then be amplified by amplifier 124 prior to being transmitted by Tx 102.

On the receiver side a portion 112 of the transmission 104 is received by receiver 140 and amplified by amplifier 126. The amplified signal may be demodulated by demodulator 128 and decoded by decoder 130. Demodulator 128 essentially performs the reverse of modulator 122. Decoder 130 performs error correction on the demodulated signal with the aim of recovering the chip string output by selector 118.

Each successive sequence of Ne chips of the decoded chip string may be compared with Ra 114a and Rb 114b to determine which of the pseudorandom sequences most closely corresponds with the sequence of N_{c} chips. A bit value (key bit value) may then be assigned to the sequence of N_{c} chips by PRN determination section 134. For example, if the Ne chips corresponds most closely with Ra 114a, a bit value of “0” may be assigned, whereas a bit value of “1” may be assigned if the Ne chips correspond most closely with Rb 114b. A difference between the decoded chip string and the assigned pseudorandom sequence can be monitored by a bit error rate (BER) determination section to obtain a chip error rate (CER) (the chip error rate may also referred to as bit error rate herein, depending on context) for the reception of the transmission 104. As described further below, a determination as to whether the transmission is secure or has potentially been intercepted may be made based on the BER. For example, according to some embodiments, PRN determination section 134 may determine that the transmission has potentially been intercepted based on a deviation of the obtained BER values from expected BER values.

In this example it is assumed that the pseudorandom sequences are known to both the transmitter and receiver, and they may be shared between the transmitter and receiver in any suitable manner. For example, they may be established at the setup of the system, transported over another link, etc. In some examples the pseudorandom sequences may be updated via the transmission 104. The pseudorandom sequences may be a shared secret between the transmitter side and receiver side. Updating the pseudorandom sequences may contribute to the security of the system 100.

FIG. 1B shows another interception scenario, with a more sophisticated interceptor 106 than in FIG. 1A. In this example, the components on the transmission side and reception side are the same as in FIG. 1A, as such not all are shown, and the descriptions are not repeated.

In FIG. 1B the interceptor 106 uses an amplification attack, in which an eavesdropping device is constructed which collects all (or a large portion, such as a majority) of the signal from the link's beam using receiver 108 and amplifies it using amplifier 136, providing extra signal to the interceptor 106 for decoding. The interceptor 106 then retransmits the remaining energy (e.g. at an energy that matches the energy of the signal received by the interceptor 106 at receiver 108) using transmitter 138 along the link (i.e. to receiver 140) with the goal of avoiding detection.

A more complex attack can be made by regenerative interception in which the interceptor 106 receives the entire signal (or a large portion of the signal), demodulates it, then uses it to generate a new, ostensibly identical signal at an identical power level toward the receiver.

### Bit Error Rate on Low Signal to Noise Link

The Shannon limit for data capacity describes limits on data transfer imposed by thermal noise. FIG. 1A illustrates a point-to-point link, and so spreading path loss can be assumed to be negligible. Further, for the purpose of explanation, it is assumed that the link operates at frequencies that incur negligible absorption loss. In these circumstances, noise in the environment and components will limit the error performance according to the Shannon formula, which compares the signal power S at the receiver to the total noise power received N to determine the ultimate data capacity C using the available bandwidth B as

$$C = B {log}_{2} ( 1 + S / N ) . \qquad ( 1 )$$

To encode data on a link the signal may be modulated after applying ECC (e.g. Forward Error Correction (FEC) coding) is employed to permit detection and correction of errors in reception. In general, no modulation and coding scheme has managed to achieve the capacity suggested by this fundamental limit but some coding schemes such as LDPC are beginning to approach it. Schemes such as LDPC are methods aiming to correct for transmission errors, which can result in increased data capacity. For low values of signal to noise ratio (SNR), ECC schemes are able to reduce bit error rate (BER) until a critically low level of SNR is reached after which error correction becomes impossible and the BER rapidly rises.

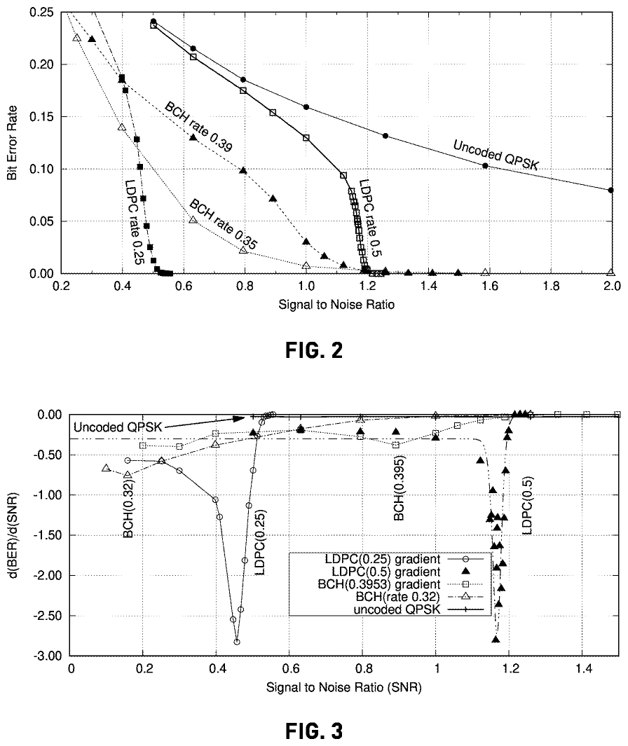

If a communication link using one of these schemes is used to transmit data at a rate approaching its maximum, the number of errors (bits decoded wrongly) increases until the BER approaches 0.5 and no data is decoded correctly. In effect, at these low SNRs the noise naturally occurring in the system is such that the data is unrecoverable. FEC coding schemes operating at a low SNR generate increasing numbers of bit errors as SNR further decreases, just the same as uncoded channels. FIG. 2 shows the bit error rate for an uncoded Quadrature Phase Shift Keyed (QPSK) modulated signal compared to four examples exploiting FEC using this same modulation scheme. Two example codes are shown in FIG. 2; Bose-Chaudhuri-Hocquenghem codes (BCH) are compared to Low Density Partiy Check codes (LDPC). However, other codes could be used instead. For coded data, some of the transmitted data bits are used to detect and correct the bits errors. Consequently not all of the bits transmitted on the channel are payload data and this means that the data rate is lower than otherwise. For example, for LDPC at rate 0.5, half the bits are used for error correcting and the other half are used for the data. The relative number of error correction bits controls the level of SNR at which the code can recover all the data with minimal errors. More error correcting bits makes the overall data rate lower but lowers the SNR limit required for a given BER.

FIG. 2 shows the results of simulations of a communication link to investigate the BER vs SNR curves with the SNR values plotted in linear terms. These BER curves are produced by means of Monte Carlo simulation. The specified SNR values are stepped through one at a time. For each step, the corresponding additive white gaussian noise (AWGN) variance is determined to provide the required SNR. Random binary values are determined with equal 0/1 probability, which are used as the transmitted data. For the case of channel coded data, the binary data undergoes coding followed by QPSK modulation. For uncoded cases only modulation is applied. At the receiver, AWGN is then added to the received data. The signal is then demodulated and decoded. Finally, the number of bit errors in the packet is determined by comparing the received data with the transmitted data. This process is repeated until at least 105 errors have been accumulated before proceeding to the next SNR value.

For the uncoded QPSK link in FIG. 2, the BER is already approaching 1 in 10 (0.1) for SNR of 1.6 with a gently rising error rate as SNR further decreases. In strong contrast to this behaviour are the coded links where, on this linear scale, bit error rates stay very low, e.g. below 1 in 100 errors, until a region close to a threshold SNR, SNR_{crit}, is reached after which the link rapidly degrades back to error rates comparable with the uncoded link. The value of SNR_{crit} depends on the coding and modulation scheme. Of the two coding schemes shown in FIG. 2 the strongest transition occurs for LDPC coded signals. Other coding schemes could alternatively be used, e.g. Polar codes.

FIG. 3 shows the respective gradients of the BER curves of FIG. 2. The uncoded QPSK transmission has a very modest slope whereas the two coding approaches are much stronger. The SNR value at which the maximum gradient occurs may be used quantify SNR_{crit}.

### Secure Link

Examples herein take advantage of the rapid increase in BER when a coding scheme is breaking down in order to achieve security against eavesdropping. Using the link at or very near to its SNR_{crit} means that the BER becomes very unstable with respect to decreasing SNR. By measuring the BER, one can detect if anything is impeding the link and changing the SNR. The BER may be determined continuously, for example.

All schemes for intercepting signals on the link require the eavesdropper to collect some of the transmitted link power and hence reduce the overall SNR for the link. This configuration is similar to that used by microwave beam waveguides where over 99.9% energy capture has been reported. Note that the eavesdropper must also have a low enough SNR such that it can satisfactorily demodulate and decode the victim signal.

Examples herein may include a link, such as that shown in FIG. 1A, that has the SNR set just above the critical point for the selected coding scheme, where the operating BER is close to rising rapidly. In this potentially unstable condition any increasing noise or loss of signal will rapidly generate a very large number of bit errors. This is contradictory with the normal operation of such links for which the margins are generally set to maintain a required BER.

For the purposes of explanation, the arrangement of FIG. 1A will be assumed to have certain properties. These properties are achievable, at least approximately, in many practical systems without undue cost or difficulty. However, each of these properties may be relaxed in a practical system, e.g. where a lower certainty of detecting an interceptor may be tolerated. The assumptions are as follows:
It is assumed that all, or nearly all the power transmitted in the link is received by the receiver in normal operation. This limits the signal power that can be received by an interceptor 106 without receiving at least a portion of the signal in the link.
It is assumed that the majority of the noise power is dominated by the receiving electronics. For example, such that the majority of the noise power (e.g. more than 50%) arises from the receiving electronics.
It is assumed that the receiver 140 is of high quality in terms of noise performance and that no significantly lower noise receiver exists: it is the best available. This allows us to make assumptions about the maximum performance of an interceptor device 106, such that an eavesdropping receiver 108 can, at best, have a comparable noise performance to the receiver 140.

As noted above, these properties are for the purpose of explaining an idealised system, and are not strictly required in practical systems.

A rapid change from a stable channel to an unstable channel with reducing SNR, e.g. represented by a steep increase in BER as SNR is reduced, results in a channel that is sensitive to a reduction in received signal power that may be indicative of an interception of some or all of the signal by an eavesdropper. Of the coding schemes shown in FIG. 2 and FIG. 3, LDPC provides the steepest gradient (largest absolute value of gradient) in BER with SNR. BCH has a maximum gradient of −0.75 (for rate 0.32) and −0.38 (for rate 0.39) whilst LDPC is −2.8 (for rate 0.5) and −2.82 (rate 0.25).

Taking the LDPC case with coding rate 0.5 there is a very strong maximum negative slope of d(BER)/d(SNR)=−2.8 at SNR=1.18. To provide the greatest sensitivity to interception with this link, the nominal SNR could be fixed at this value (SNR_{crit}=1.18) by adjusting the transmit power and determining the resulting BER. Using the link at this SNR, errors would be expected, with reference to FIG. 2, at a rate of BER~0.05 and any increase in this value would be an indicator of potential interception or link occlusion, and a sign of potential insecurity. In practice, this rate of errors (about 1 in 20) may be inconveniently high for some links in normal operation. To address this, an operating point slightly higher than SNR_{crit} may be selected, where the BER is much lower. For example, an SNR of 0.53 for the LDPC (0.25) case, where negligible numbers of bit errors would be expected(BER=3.41×10⁻⁴) for normal operation, while any reduction in the received signal will rapidly generate a rising BER as the SNR drops toward and through SNR_{crit}.

The link of FIG. 1A may be viewed as a BER test system with the transmitter sending one of two possible pseudorandom sequences. These pseudorandom sequences need not be orthogonal but may have a low correlation to one another, e.g. such that they are easily distinguished even with, for example, up to 20% of their bits (chips) in error. The pseudorandom sequences may be chosen to be reliably distinguished from each other at the normal bit error rate of the link, but similar enough to each other to be ambiguous at the bit error rate that a potential stand-off attacker (described later) would be expected to encounter. This allows the key bits to be recovered reliably at the receiver 140, while preventing an eavesdropper from recovering the key bits reliably.

The receiver side expects one or the other of these two PRSs Ra 114a or Rb 114b and compares the chip stream arriving to a stored version of each of the PRSs, to determine which of Ra 114a or Rb 114b was sent. For example, a number of chip differences between the received chip stream and each of Ra 114a and Rb 114b may be determined and the PRS with the lowest number of chip differences from the received chip stream may be assigned as the received bit (Ra 114a or Rb 114b). The number of chip differences between the chips of the assigned bit and the received chips may be used to determine a BER (chip error rate, in this case). The BER may be determined continuously as the chip stream is received. In other examples, the BER may be determined periodically, or at time intervals.

Suitable PRS pairs, Ra 114a and Rb 114b, may be produced as follows. A random chip string of length N_{c} (where N_{c} is the PRS length) may be generated and assigned to Ra 114a. Rb 114b may be generated by flipping 2×BER₀ bits (each flip switching a “0” to “1”, and vice-versa), where BER₀ is the target bit error rate of the link under normal conditions (e.g. in the absence of an interceptor 106). This is merely and example, and Ra 114a and Rb 114b may alternatively be generated in other ways.

In some examples, synchronization of the received chip stream can be achieved with a sliding correlator. In this case, correlation is repeated at a range of time offsets. The time offset that produces the highest correlation indicates the synchronisation point. For each of the PRSs, one will have a high maximum correlation and one a low correlation allowing the receiver to identify which PRS is being transmitted at any particular time. Once the PRS is identified, chip by chip comparison delivers the BER at which it was received.

The receiver may report the BER back to the transmitter by means of a back channel. The transmitter may then determine whether the reported BER is indicative of a potential interception of the transmission 104. Alternatively, or additionally, the receiver may determine whether the determined BER is indicative of a potential interception of the transmission 104. In some examples, the receiver side may additionally or alternatively report the BER to a component of the system other than the transmitter 102, and that other component of the system may determine whether the reported BER is indicative of a potential interception of the transmission 104. Accordingly, the BER may be used to secure the link.

Security may be provided as follows. If an eavesdropper attempts to listen in on the communications, it would have to introduce a detector 108 to achieve this. With a link 104 running at or close to its critical bit error rate, almost all the transmitted signal power must be received in order to successfully decode the data. Merely “sniffing off” off a small portion of the signal energy 110 would not be sufficient for the eavesdropper 106 to successfully intercept and decode the data stream. However, this would reduce the signal power available at the legitimate receiver 140 thus reducing its SNR and resulting in a dramatic increase in BER due to the critical nature of the link 104. This increase in error rate indicates that interception is being attempted allowing identification of the link as potentially insecure. It is noteworthy that monitoring the SNR or received power would not typically allow the interception to be detected. BER provides a much more sensitive indication of potential interception, particularly when a codding scheme is used that exhibits a rapid change in BER with SNR.

The performance of the link may be predicted by evaluating the chip error probabilities when transmitting a chip sequence across the link. For the purpose of this evaluation a memory-less channel is assumed, so that each code chip transmitted has an equal probability of error p, then in transmitting n code chips we may obtain k errors. The probability of k errors in n code chips is then given by binomial statistics as

$$P = {C}_{n , k} {{p}^{k} ( 1 - p )}^{n - k} , \qquad ( 2 )$$

where C(n,k) is the binomial coefficient n!/k!(n−k)!. Using this formula the channel behaviour may be tested, as follows.

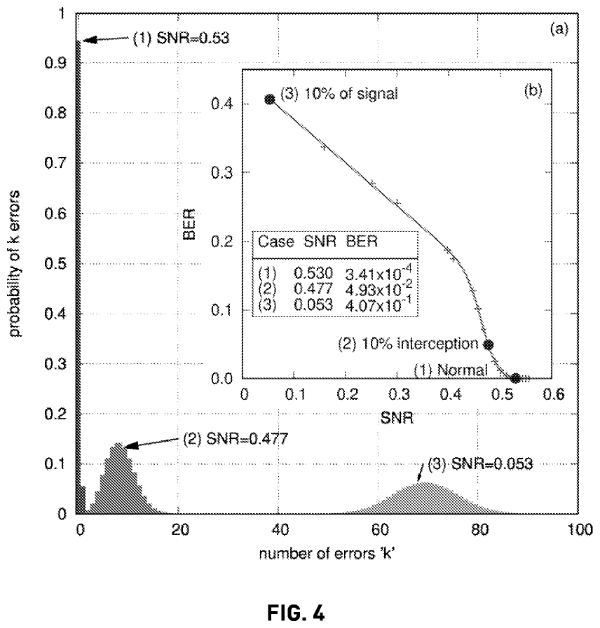

The inset to FIG. 4 shows BER vs SNR results, for an LDPC coding at rate 0.25. Three conditions shown as solid data points:
i. a SNR of 0.53, corresponding with a normal link according to an example,
ii. a SNR of 0.477, corresponding with 90% of the normal signal being received, e.g. due to 10% interception of the signal, and
iii. reception of 10% of the signal, e.g. corresponding with the signal received by an interceptor 106.

For the purposes of this evaluation it is assumed, as noted above, that the receivers used by the link and the eavesdropper are identical and represent the best available in terms of their bandwidth and noise figure. Using these values in equation 2 we can obtain results like those shown in the main part of FIG. 4, which shows the error probability distribution for three different SNR operating points corresponding with conditions i to iii, above. In this example 170 chips are transmitted, representing one bit of the key being delivered (this is the length of the PRSs in this example) and the corresponding probable number of chip errors are evaluated.

### Eavesdropping Scenarios

Four eavesdropping scenarios are considered, illustrating how the eavesdropping may be detected according to the example system described above. Data on the link, in this example a shared non-repeating encryption key to be distributed, is sent by selection of one of the two pseudo random sequences for each bit of the key. Due to spreading using the PRS, the signalling scheme for the actual data is well clear of the Shannon bounds and is thus reliable. This data rate, R_{D}, is much lower than the chip rate, R_{C}, of the pseudo random sequences, i.e., R_{C}>>R_{D}. These are related by

$${R}_{D} = \frac{{R}_{C}}{{N}_{C}} , \qquad ( 3 )$$

where N_{c} is the number of chips in the PRS. Since the effective rate for the bits of the encryption key is lower than the chip rate, the key data may be recovered even when the chips are received with low SNR. As the chip length of the PRSs is increased, the effective key bit rate is reduced, such that only a small SNR is required for successful interception of key bits. Thus, for longer PRS, interception of the data on the link becomes possible with only a small fraction of the total beam energy being lost to the interceptor. According to examples herein, the interception is not prevented, but is detected before a significant portion of the data can be intercepted by an eavesdropper. For example, the interception may be detected within a single key bit transmission period. The PRS length N_{c} may be chosen to enable reliable detection of key bits at receiver 140 at the desired BER threshold used to detect interception, but not so long as to make it possible for the eavesdropper to decode the key. In order to detect a particular BER, denoted as B₀, one must transmit at least N_{c}≥1/B₀ bits. Thus, the value chosen for the threshold BER may be used to set the length of the PRSs.

Since one bit of the encryption key being distributed is transmitted with each complete pseudo random sequence, the very rapid increase in BER associated with interception of the signal enables the detection of the interception within, for example, just a few bits of the key. Even if the eavesdropper can achieve a better noise floor than the main link's receiver 140, they are unlikely to be able to decode the key before their interception is detected and are also receiving very much less than the optimal signal strength in most simple attack scenarios. Swift detection of interception also precludes the possibility of the eavesdropper gaining knowledge of which PRS represents 1's and 0's. To illustrate this, consider an eavesdropper with a maximum of 1/57 of the SNR relative to the main link (i.e. relative to the SNR at receiver 140 under normal conditions). Compared with the normal link, the eavesdropper would require 57 times the time to receive the code, by which time the interception could be detected and appropriate action taken, such as shutting down the link.

### Scenario 1—Man in the Middle Attack

Using the binomial statistics in equation 2 the effect of an eavesdropper attempting to read the key by inserting an antenna to “sniff off” some of the link power can be illustrated. This corresponds with the situation illustrated in FIG. 1A. In this example, it is assumed that the link described in FIG. 4 is being run a little above SNR_{crit} at an SNR of 0.53, and that the eavesdropper intercepts 10% of the link power. In this arrangement, the three conditions (1) to (3) shown in FIG. 4 correspond, with (1) the normal channel, (2) the channel in the presence of the interception (90% of signal received), and (3) the signal received by the eavesdropper (10% of signal received by interceptor 106). The inset table in FIG. 4 shows the SNR and BER values for each of the three conditions.

Case (1) corresponds with the unperturbed channel where SNR is highest, at 0.53. In this case, there is very low BER with 94.4% probability of zero chip errors. This would be the usual condition for this link. Users would generally see no more than 1 error within most key bit exchanges and all the bits of a key can be transmitted error free (i.e. the key bits may be reliably recovered).

Case (2) corresponds with the signal received at receiver 102 when an eavesdropper is trying to obtain the key by sniffing off 10% of the link power. Consequently, the eavesdropper reduces the SNR to 0.477 such that error rates rise and the probability of zero errors drops to less than 1%. The mean number of chip errors in each key bit rises to 8, indicating that interception is likely to be occurring. In some cases, chip error rates may be observed for several key bits to establish that eavesdropping is occurring. According to this arrangement, the eavesdropping can be reliably detected before a complete key is transmitted, for a typical key length.

Case (3) corresponds with the signal the eavesdropper would receive when intercepting 10% of the transmitted power. At this level the eavesdropper would be unable to interpret the code transmitted, having typically around 70 bit errors for each 170 bit packet. The eavesdropper would not be able to interpret key bits correctly, with each key bit being impossible to correlate with either of the pseudo random sequence employed to represent the two possible states of a key bit.

Accordingly, in this scenario the eavesdropper would be detected and also unable to recover the key.

### Scenario 2—Amplification Attack

The amplification attack method is shown in FIG. 1B. An eavesdropping device (interceptor 106) collects all (or essentially all) of the signal from the link's beam, amplifies it, providing extra signal to the eavesdropper for decoding, and then retransmits the remaining energy along the link to avoid detection. A link budget calculation can be used to analyse a link where an amplifier attack is being performed. For the purposes of this calculation it is assumed that the link is 100% efficient in terms of energy capture and that the beamwidth at the receiver 102 or the interceptor's receiver 108 is smaller than the antennas of the receivers 102, 108. The SNR for the unperturbed link may be shown to be SNR₀=S₀/(N₀+Nᵣ) where the signal power arriving is S₀ and the noise powers from the transmitter and receiver are No and Nᵣ, respectively. For this example, it is assumed that the interceptor 106 adjusts its amplifier gain and the fraction of power that it keeps so that the link's legitimate receiver still has the same arriving signal power. This gives a new SNR of SNR_{X}=GᵢS₀/(Gᵢ(N₀+Nᵣ)+GᵣNᵣ), where Gᵢ and Gᵣ are the gains of the interceptor amplifier 136 and receiver amplifier 126, respectively. Hence, the amplifier attack raises the SNR by a factor of

$${R}_{amp} = \frac{{SNR}_{X}}{{SNR}_{0}} = \frac{{G}_{i} ( {N}_{0} + {N}_{r} )}{{G}_{i} ( {N}_{0} + {N}_{i} ) + {G}_{r} {N}_{r}} . \qquad ( 4 )$$

Here, N₀ is the noise in the link arising from the transmitter plus any environmental noise that is incident on the receiving antennas. Once again, it is assumed that both the legitimate receiver 140 and the eavesdropping receiver 108 have identical capabilities with identical gains (Gᵣ=Gᵢ) and noise levels (Nᵣ=Nᵢ). Equation 4 shows that Rₐₘₚ is always less than 1. In general, unless the channel and transmitter noise No is dominant then Rₐₘₚ will always be considerably below 1 with a limiting value of 0.5 when N₀→0.

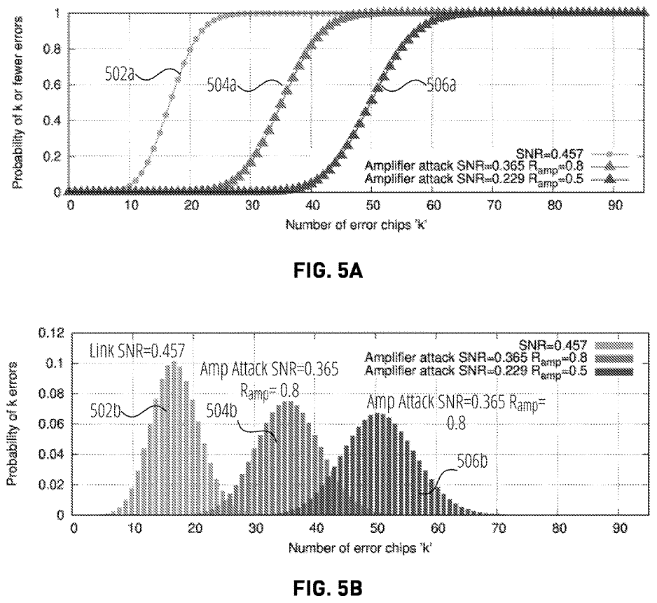

FIG. 5A and FIG. 5B show statistics for this attack. FIG. 5B, shows the probability of k chip errors in a 170 bit key as a function of k, and FIG. 5A shows the cumulative probability of k chip errors in a 170 bit key with increasing k, i.e. the probability of k or fewer errors in a key bit. In this example, the link is being run at SNR_{crit}=0.457 with LDPC at rate 0.25. The normal channel, shown by 502a and 502b, exhibits a mean error rate of 16 chip errors per key bit. FIG. 5A and FIG. 5B also show the probability of errors in the signal received at receiver 140 when Ramp=0.5 and 0.8. The case Ramp=0.5 is shown by 506a and 506b, and Ramp=0.8 is shown by 504a and 504b. Even with the higher value of Rₐₘₚ=0.8, the mean chip errors per key bit rises to 36, such that the perturbed channel is distinguishable from the normal channel by using noise statistics. Thus, although the amplifier attack may enable key bits to be intercepted by the eavesdropper, the interception may be detected before the whole key has been transmitted.

### Scenario 3—Regenerative Attack

A more complex attack can be made by regenerative interception where an eavesdropper receives the entire signal, demodulates it, then uses it to generate a new, identical signal at an identical power level toward the receiver 140. In this case, the detection of eavesdropping is potentially more difficult. If the link is being run at an SNR too far above SNR_{crit} detection may be nearly impossible. For example, in the arrangement of FIG. 4 with the channel operating at a SNR of 0.53, the SNR may be too high to reliably detect a regenerative attack, in some implementations. However, if the link is run at or close to SNR_{crit}, it is possible to detect this kind of attack.

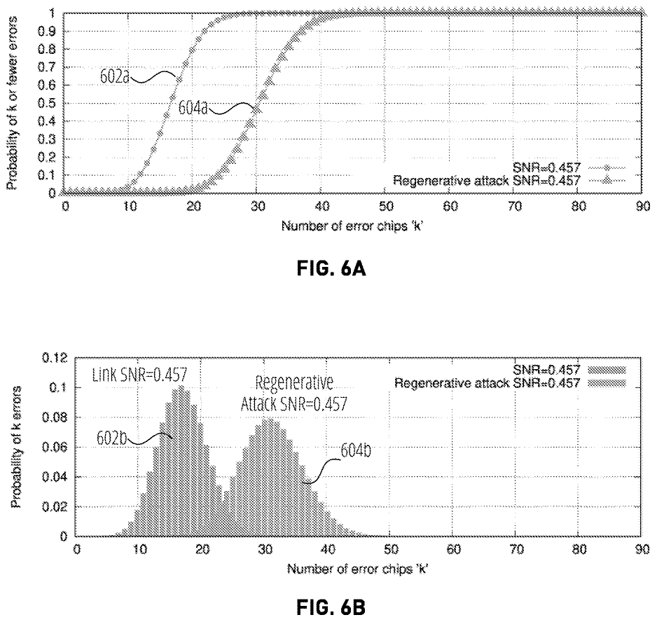

The legitimate link may be run in such a way that there are always a detectable number of chip errors. In this case the regenerator may reproduce the data it receives faithfully, but it cannot avoid that data already containing these errors due to its own receiver limitations (which are assumed to be approximately the same as the receiver 140). The errors can only increase in number when the legitimate receiver 140 receives the regenerated signal; each receiver unavoidably adds noise. The presence of the regenerator essentially changes the statistics of the bit errors thus modifying equation 2, which becomes

$${P}_{rg} ( k ) = {{C}_{n , k} ( 2 p ( 1 - p ) )}^{k} {( 1 - 2 p + 2 {p}^{2} )}^{n - k} , \qquad ( 5 )$$

where the parameters are the same as in equation 2. This arises because each receiver will experience chip errors, mostly in differing chips and generally increasing the overall number. Using equation 5, one can explore the impact on the chip error statistics for the LDPC rate 0.25 link when run at SNR_{crit}. FIG. 6A and FIG. 6B show the predicted chip error statistics in a similar manner to FIG. 5A and FIG. 5B. The normal channel is shown as 602a and 602b, while the signal received at receiver 140 following the regenerative attack is shown as 604a and 604b. The interception increases chip error rates by a significant amount from a mean of 16 to 31. Whilst this is a smaller contrast as compared to the amplifier attack at Rₐₘₚ=0.8, it is still a detectable condition. The slightly greater overlap between the error distributions 602b and 604b means it may be appropriate to observe the channel for a number of key bits to achieve a positive detection of the regenerator, in some implementations.

### Scenario 4—Stand-Off Attack

In the previous scenarios the interception device is located between the transmitter 102 and receiver 140, and the use of a system, such as a focused beam system, with efficient transmission was assumed. A stand-off attack, in which the interception device is located with an angular offset away from the direct path, would not typically be practical in efficient systems.

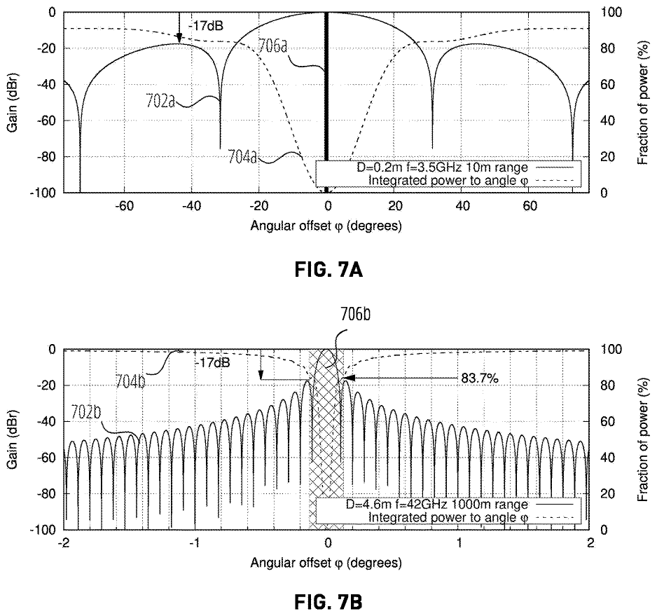

The assumption of a focused beam system, or similar, can be relaxed. This example considers the use of a less efficient link subjected to a standoff attack. The use of antennas, such as a parabolic reflector antenna, for forming a point-to-point link allows a low level of energy to spill passed the receiving antenna due to the sidelobes in the antenna radiation pattern. The exact profile of energy versus angle depends on antenna design detail. The following illustrates two examples, the first example uses small reflector antennas (20 cm diameter transmitting at 3.5 GHz over a range of 10 m) which exhibit relatively high side lobe energy. The second example is for a much higher frequency and wider diameter reflector (4.6 m diameter transmitting at 42 GHz transmitting over a range of 1 km). The far-field radiation pattern may be closely approximated using equation 6

$$P ( ϕ ) = {{P}_{0} [ \frac{2 {J}_{1} ( π D sin ( ϕ ) / λ )}{( π D sin ( ϕ ) / λ )} ]}^{2} , \qquad ( 6 )$$

where D is the diameter of the reflector, P₀ is the launched power, λ is the wavelength of the signal, J₁(x) is a Bessel function of the first kind and φ is the angular offset from the beam centre. FIG. 7A shows the beam pattern for the first case (20 cm diameter transmitting at 3.5 GHz over a range of 10 m), and FIG. 7B shows the beam pattern for the second case (4.6 m diameter transmitting at 42 GHz transmitting over a range of 1 km). These figures show the gain 702a and 702b with angular offset from the line connecting the transmitter 102 and the receiver 140. The integrated power 704a and 704b is also shown.

The arrows mark the highest levels of power outside of the main beam, which are both −17 dB. In both cases a matching identical dish is assumed as the receiver. The shaded portions 706a and 706b show the portion of the beam captured by the receiver 140. The smaller 0.2 m diameter dish, even though it is being operated at short range of only 10 m, has the majority of its radiated power outside of the receiver's footprint with only 0.13% actually being received. The Larger 4.6 m diameter dish with much shorter wavelength signals generates a much tighter beam where more than 83% of the radiated energy is captured by the matching receiver dish.

In the first case (FIG. 7A) the majority of the signal power misses the receiver 140 and is available to a standoff eavesdropper. As such, the system may be vulnerable to a stand-off attacker, in the absence of other measures to secure the link.

In the second case (FIG. 7B) a standoff eavesdropper can, at best, acquire only 16.3% of the signal energy and only then by collecting all the sidelobe energy. The SNR and the PRS pair may be selected so that the associated level of error in the eavesdropper's data renders reliable decoding impossible, even assuming the eavesdropper is able to collect all 16.3%.

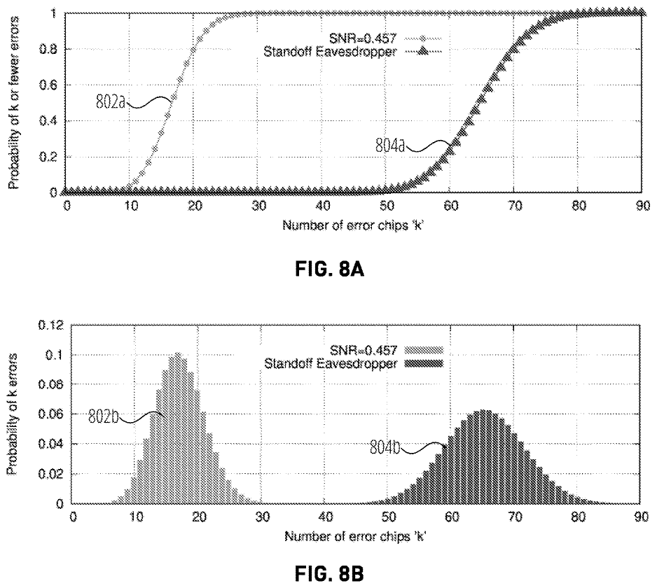

FIG. 8A and FIG. 8B show the chip-error analysis for the link of FIG. 7B, assuming that the link is adjusted so that its receiver is operating with an SNR of 0.457. The probability of k errors 802b in a 170 chip key bit transmitted via the link is shown in FIG. 8B, and the corresponding cumulative probability 804a is shown in FIG. 8A. The chip errors 804b and cumulative chip errors 804a are also shown for an eavesdropper, assuming that the eavesdropper is able to collect all of the lost signal energy. In most systems, collection of all of the lost energy by the eavesdropper is unlikely to be practical, such that in most real systems the eavesdropper would experience even greater errors. Whilst the link operators would not observe any change in the link statistics to identify this attack, the attack it would still fail. Even collecting all of the lost energy, the eavesdropper has to contend with on the order of 65 chip errors per key bit, making the key impossible to decode reliably. Where the link only transmits the key once, an attacker may not rely on signal averaging or other methods to acquire the full key. This situation can be made even more secure by raising the frequency and narrowing the beam to further reduce the fraction of lost energy, with operation at optical frequencies being attractive but without requiring the complexity of traditional QKD techniques.

### Eavesdropper Detection

The scenarios above demonstrate that monitoring of the chip error rate (e.g. continuous monitoring) is sufficient to identify when any of these attacks are being made, apart from the stand off attack. However, appropriate design of the link (e.g. good antenna design) may prevent a successful stand off attack, by limiting the signal energy available to the interceptor 106 to a level that results in high chip error rates at the interceptor 106, preventing reliable reception of the data by the interceptor 106.

In the examples above, assuming the performance of all receivers used (i.e. legitimate and eavesdropper receivers) is comparable, attacks can be reliably detected, whether simple interception attacks, attacks based on amplifiers or attacks using regenerators. In general, the reporting (e.g. continuous reporting) of the chip error rate provides for this detection.

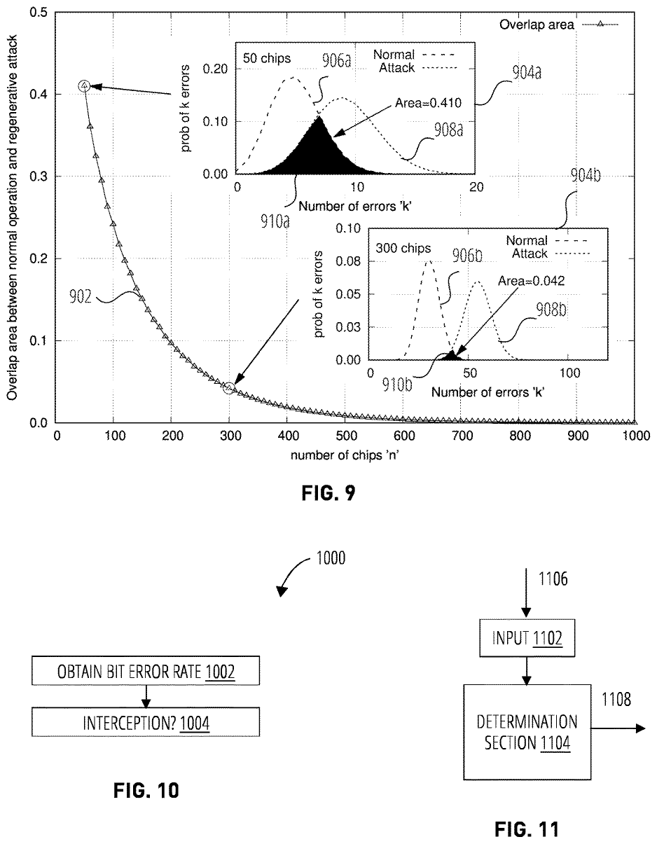

FIG. 9 shows the overlap 902 between error probability plots for received signals, in normal links and in links under attack, as a function of the number of chips in a key bit. Inset 904a shows the probability of k errors for different k in a normal channel 906a and a channel that is being attacked 908a, where the key bit length, n, is 50 chips. The overlap of these curves 910a is shaded. The main graph in FIG. 9 plots the overlap of the curves corresponding to normal and attack situations for different key bit length. Inset 904b shows a similar plot for a key bit length, n, of 300 chips.

The degree of overlap between the chip error rate distributions can be continuously adjusted by changing the number of chips in the PRS making up a key bit. The overlap area decreases exponentially with increasing chip number, with a factor of 10 improvement between 50 and 300 chips. The length of PRS used for each of the key bits should then in general be the longest that can be used whilst still maintaining the minimum required key rate. The lower the area of overlap, the more robust the detection of an attack.

In some examples, any perturbation in the chip error rate (or any increase above a preset threshold) may be treated as an indication of a potential interception of the link. In other examples, additional operations may be carried out to differentiate an increase in chip error rate due to link interception from an increase due to other causes. In the arrangement of FIG. 1A, PRN determination section 134 may determine whether or not the chip error rate is indicative of an interception on the link. This determination may be carried out on the receiver side, transmitter side, or remotely from both the transmitter and receiver (with suitable reporting of the chip error rate or similar information from the receiver to the transmitter or remote device).

As described above, chip error rate may be used to sensitively determine changes in signal-to-noise ratio from the link. The error statistics of the wanted transmitted signal are under the control of the system. This allows the system to choose the wanted signal to exhibit very different error statistics compared with changes in chip error rate caused by other events. For example, for a point-to-point link, the chip error rate could be set up to exhibit a constant level. With an interception device subsequently inserted in the link, the chip error rate would rapidly increase, thus indicating an event and that action should be taken.

System performance may be improved by avoiding excessive false alarms, and so it is beneficial to select a suitable decision threshold based on comparison between the measured CER signature and stored signatures. One such method is by training a neural network with chip error rate signatures relating to a wide range of items and geometries that might occlude the link such as birds or weather events; as well as items that would resemble an eavesdroppers' antenna. Lab testing to identify a range of link perturbations that may be used to train the neural network prior to operational deployment. Signatures may be collected for a wide range of non-malicious perturbations as well as signatures synthesising a malicious eavesdropper. Due to differences in materials, geometries and temporal behaviour, non-malicious perturbations are expected to differ from those of a malicious eavesdropper. For example, an eavesdropper would typically consist of a metallic structure (antenna) of a certain size and geometry inserted into the link in a preferred way, creating a related chip error rate signature. In some examples, the learning process may be carried out once and the configuration copied to all deployed units, along with updates being issued during operation. These stored signatures are then compared with those obtained during operation and used to determine whether a chip error rate signature should be attributed to an eavesdropper.

### Further Embodiments

FIG. 10 illustrates a method 1000 of monitoring a transmission. At 1002 one or more values of bit error rates are received or obtained. The bit error rate may be the bit error rate of the signal received at a receiver 140 (e.g. a chip error rate, as described in the previous examples). At 1004 it is determined whether the transmission has been intercepted, based on a deviation of the obtained BER values from expected BER values. The method 1000 may be implemented according to any of the preceding examples, for example.

FIG. 11 illustrates a device suitable for performing the method 1000 of FIG. 10. The device includes an input 1102 to receive the bit error rate 1106. The input 1102 provides the bit error rate 1106 to a determination section 1104, which may correspond with the PRN determination section 134 of FIG. 1A. The determination section 1104 may determine whether or not the bit error rate 1106 is indicative of an interception of the transmission, and output the result of the determination 1108. The input 1102 and determination section 1104 may be implemented in a program for a computer, software, firmware, hardware, etc. or a combination of these. For example, input 1102 may be a buffer and determination section 1104 may be a software module executed by a processor.

According to the method 1000, a link may be operated at or around a target SNR, which may be referred to herein as a first SNR. The expected BER may correspond with the transmission having the first signal to noise ratio (SNR) at the receiver. The first SNR may be SNR_{crit}, or may be a SNR value close to SNR_{crit}. As described above, SNR_{crit} may be defined as the SNR value at which the maximum gradient in BER occurs. Thus, SNR_{crit} is a SNR value at a minimum in d(BER)/d(SNR), where BER is the bit error rate at the receiver. The maximum gradient occurs at a minimum in the derivative because BER decreases with increasing SNR, such that the gradient is negative; the absolute value of the gradient is maximum at SNR_{crit}.

Where the link is to have high sensitivity to interception, the first SNR may be set equal to, or very close to SNR_{crit}. However, in some implementations this may result in an undesirably high chip error rate at the receiver 140 under normal conditions. In such cases, the first SNR may be set higher than SNR_{crit}, but close enough that interception of the link will cause a detectable increase in the chip error rate.

In some examples, the first SNR is chosen such that a difference between the first SNR and SNR_{crit} is less than a full width at half maximum of d(BER)/d(SNR) with SNR. In some examples, the difference between the first SNR and SNR_{crit} is less than a half width at half maximum of d(BER)/d(SNR) with SNR. The difference between the first SNR and SNR_{crit} may be chosen to be less than half of the full width at half maximum of d(BER)/d(SNR) with SNR.

In some examples, the critical value, SNR_{crit}, may be determined in order to set the first SNR at or close to SNR_{crit}. In some examples, a SNR corresponding with a negative peak in d(BER)/d(SNR) may be determined, and this may be used in setting the first SNR.

In some examples, an upper SNR value may be determined, such that a difference between the upper SNR value and the critical value is less than or equal to the full width at half maximum, and the first SNR may be set to less than the upper SNR value, or may be set to be equal to the upper SNR value.

The first SNR may be chosen for a particular system taking into account the nature of the link (portion of transmitted power received at the receiver 140, coding and modulation schemes, etc.), and a target degree of certainty in the security of the link.

Where the data carried by the link is relatively low-value it may be acceptable to tolerate the possibility of an attacker recovering the data where the effort by the attacker would likely outweigh the value of the data. For example, where the receiver 140 receives 40% of the transmitted power, an attacker could, in theory, obtain as much, or more, of the transmitted power as the receiver 140, and in that case could potentially recover the data without being detected. However, where the lost 60% of the energy is widely spread, it may be impractical for an attacker to receive a sufficient portion of the signal to recover the data, or it may be difficult for such collection to be performed in a clandestine manner. On the other hand, for important data, a portion of the signal corresponding with at least 50% of the transmitted power may be collected (or more than 50%), such that an interceptor 106 with comparable reception equipment would be unlikely to be able to recover the data using a stand-off attack. If yet more security is desired, a portion of the signal corresponding with at least 60% (for example) of the transmitted power may be collected. This may allow for the possibility of a stand-off attacker that is able to collect all of the lost signal and use receiving equipment with better SNR characteristics than the receiver 140 of the system. Thus, the transmission 104 may have the expected BER at the receiver 140 when a power of the signal at the receiver 140 is: at least 40% of the power of the transmission 104, or at least (or more than) 50% of the power of the transmission 104, or at least 60% of the power of the transmission 104. Other values could be chosen to suit a particular implementation.

The transmission 104 may be encoded using any suitable encoding scheme, or may be unencoded. For example, the transmission 104 may be encoded using one of Forward Error Correction (FEC), Low Density Parity Check (LDPC) codes, Bose-Chaudhuri-Hocquenghem (BCH) codes, Polar codes, Turbo codes, Reed Solomon codes, Fountain (or related) codes, block codes (e.g., Hamming codes), Repetition codes, or convolutional codes. Any encoding scheme that exhibits a strong criticality of BER to SNR may provide good sensitivity to interception of the transmission 104. Encoding schemes may be used in combination, e.g. concatenated.

The transmission 104 may be via any suitable link. In some examples, the transmission 104 is via a point-to-point link, a microwave beam, a beamformed radio link, a line of sight radio link, an optical beam, a laser, an acoustic link, near-field communication, a wired link, a waveguide, or an optical fibre.

The examples herein are modulated using QPSK, but the modulation scheme is not particularly limited, and any suitable modulation scheme could be used. For example, Quadrature Amplitude Modulation (QAM) or Multiple Frequency-Shift Keying (MFSK) could be used. In some examples, such as when the link 104 is via a cable or an optical communication channel, baseband or on/off modulation may be used. In some examples, Trellis coded modulation (TCM) may be used.

The transmission 104 may include one or more pseudorandom sequence (PRS) selected from a set of two pseudorandom sequences. Each pseudorandom sequence of the set of pseudorandom sequences representing a message bit. The transmission may carry data indicative of a key (e.g. an encryption key), with the message corresponding with the key. However, the message is not particularly limited, and so a message other than a key could be carried by the transmission 104. Because of the low SNR of the link, messages containing a significant amount of data may be undesirably time-consuming end inefficient to send. Where a key is sent, it may be used for communication between the transmitter side and receiver side. The key may be for use by the receiver side to encrypt messages to be sent to the transmitter side. The key may be used on a communication link that is similar to, or dissimilar from, the link 140.

In some examples, the set of PRSs may be include more than two PRSs. Each PRS may then carry more information than a single bit. For example, four PRSs may be used, with each corresponding to two bits, e.g. with each PRS respectively corresponding with one of (0, 0), (0, 1), (1, 0) and (1, 1).

In some examples, the pseudorandom sequences are not mutually orthogonal. This may reduce the likelihood of an attacker being able to correctly determine which PRS has been received, since orthogonal sequences can be more reliably recovered at high chip error rates.

In the method 1000 the BER may be determined by determining which pseudorandom sequence of the set is most similar to the pseudorandom sequence as received at the receiver 140 and performing a chip-wise comparison between the pseudorandom sequence as received and the determined pseudorandom sequence of the set.

During operation of the method 1000, the PRSs may be changed (e.g. updated.) This may be performed periodically, or in response to a predetermined trigger. For example, a component of the system (which may be in the transmitter side, the receiver side, or remote from both) may determine that a pseudorandom sequence update condition has been met and, in response, updating the set of pseudorandom sequences. In some examples, updated PRSs may be distributed in each key that is sent. For example, each key transmission may include Ra and Rb for use in transmitting the next key. Changing the PRSs may reduce the risk of an attacker being able to use statistical methods to recover data from the channel at high bit error rates. For example, changing the PRSs in this way may prevent an eavesdropper from combining sparse data from a standoff attack over many exchanges to achieve an effective regenerator attack later on.

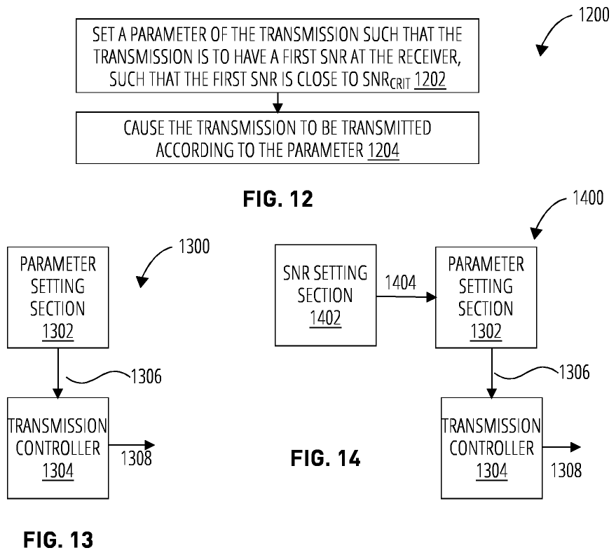

FIG. 12 shows a method 1200 for transmitting a transmission 104 to a receiver 140. According to the method, a parameter of the transmission 104 is set at 1202 such that the transmission 104 is to have a first signal to noise ratio at the receiver, and at 1204 the transmission 104 is transmitted in accordance with the set parameter. The first SNR may be set such that the first SNR is close to SNR_{crit}. The first SNR may be set such that a difference between the first SNR and a critical value is less than a full width at half maximum of d(BER)/d(SNR) with SNR. Other approaches to setting the first SNR described herein may also be used in this method.

The parameter may be one or more of a transmission power, transmission speed, bandwidth, etc. Adjusting the transmission power is typically the simplest way to control the SNR.

The method of FIG. 12 may be used in conjunction with features described in relation to the method of FIG. 11.

FIG. 13 illustrates a device 1300 suitable for performing the method of FIG. 12. The device 1300 includes a parameter setting section 1302 to set the parameter of the transmission 104. The parameter setting section 1302 provides the parameter 1306 to transmission controller 1304. The transmission controller 1304 causes the transmission 104 to be transmitted according to the parameter 1306. For example, the transmission controller 1304 may output a signal 1308 to cause the transmission 104 to be transmitted.

FIG. 14 shows another example of a device 1400 suitable for performing the method of FIG. 12. The device 1400 is similar to the device 1300, with corresponding elements having the same numbers. The description of these elements will not be repeated. Device 1400 includes an SNR setting section 1402 to set the first SNR. The SNR setting section 1402 may set the first SNR in accordance with any of the examples described herein.

The elements of FIG. 13 and FIG. 14 may be implemented in a program for a computer, software, firmware, hardware, etc. or a combination of these. For example, parameter setting section 1302, Transmission controller 1304 and SNR setting section 1402 may implemented as software modules to be executed by a processor.

A number of assumptions were made regarding the transmission and reception system, and the capabilities of the attacker in the preceding explanation. However, these assumptions do not need to be adhered to strictly in real systems. For example, as noted above, where a lower degree of certainty of detection of an interceptor 106 can be tolerated, it may be acceptable for a smaller portion of the transmitted energy to be received by the receiver 140, or it may be acceptable for the receiver 140 to have a relatively poor SNR performance, such that a potential eavesdropper can be expected to use a receiver 108 that has a better SNR performance.

Even where a high level of certainty is desired, the assumptions may be relaxed, and the parameters of the system adjusted to meet the particular requirements. For example, where the receiver 140 cannot be assumed to have a comparable SNR performance to that of a potential interceptor 106, interception may still be made impractical and/or detectable by providing a link that allows for a high portion of the transmitted energy to be received by the receiver 140, and having a SNR very close to SNR_{crit}, such that even a small portion of the signal being sniffed off by an interceptor 106 results in a detectable change in SNR.

The system described herein is particularly well suited to point-to-point links. However, it may be integrated with other technologies, such as directional modulation (e.g. as described in H. Shi and A. Tennant, “Secure communications based on directly modulated antenna arrays combined with multi-path,” 2013 Loughborough Antennas and Propagation Conference, LAPC 2013, pp. 582-586, 1 2013). The two schemes would compliment each other in that the present system provides protection from on-axis eavesdropping, whilst directional modulation provides protection from off-axis eavesdropping, making a highly secure radio link through reducing the probability of interception whilst increasing the probability of detection an eavesdropper. The system described herein may also be applied to protecting wire, waveguide or fibre communication channels, which can be considered as point-to-point.

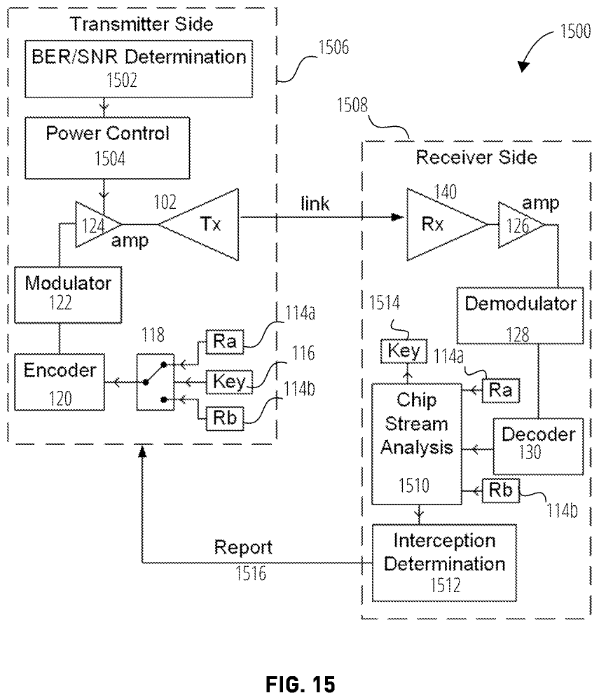

FIG. 15 shows an example of a system 1500 according to some examples. The system 1500 includes a transmitter side 1506 and a receiver side 1508, which may be the same or similar to the transmitter side and receiver side of FIG. 1A.

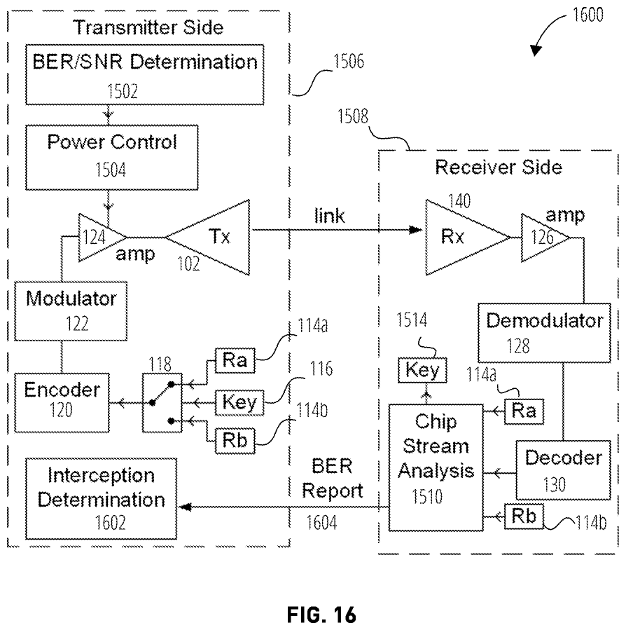

The transmitter side 1506 includes components to generate or store pseudorandom sequences Ra 114a and Rb 114b, key 116, selector 118, encoder 120, modulator 122, amplifier 124 and transmitter 102, similar to the transmitter side of FIG. 1A, and the description of these components is not repeated. The transmitter side 1506 of FIG. 16 also includes a BER/SNR determination section 1502. The BER/SNR determination section 1502 sets a target BER or SNR. The BER or SNR may be set in accordance with any of the previous examples (e.g. The SNR may be set at or near SNR_{crit}). The BER/SNR determination section 1502 may provide an output for setting a power of the transmission. The output may be indicative of the target BER, a target SNR, a target transmission power, etc. The output for the BER/SNR determination section 1502 is provided to a power control section 1504 that is arranged to control amplifier 124 to achieve the target transmission power.

In some examples, the characterisation of the expected performance to set the transmission power may be performed when the system is built or initialised. The expected performance may be based on knowledge of the performance of the components, comparison with similar systems, or measurement of the system being initialised. Where the performance of the system is measured to set the transmission power, this may include measuring the received signal in the absence of an interceptor 106. Depending on the implementation, this may be achieved, for example, by visual inspection of the path of the transmissions 104. In some examples, the transmitter 102 and receiver 140 may be placed close together, possibly even in the same room, for initialisation, such that clandestine interception would not be possible. They may then be relocated to their operational locations after initialisation. Where the main source of noise in the system is due to the receiver 140 (and possibly the receiver of an eavesdropper), the difference in noise due to the change in transmission path due to the relocation of the transmitter 102 and/or receiver 140 may be insignificant in some systems.

In some cases, the initialisation of the system may include measuring the relationship between BER and SNR.

In some examples, the target transmission power may be set as part of the initialisation of the system. In that case, the BER/SNR determination section 1502 may be implemented as a register or data storage component that stores the determined target transmission power.

The receiver side 1508 may include receiver 140, amplifier 126, demodulator 128, decoder 130, and a storage component to store pseudorandom sequences Ra 114a and Rb 114b. These elements of the receiver side 1508 may be similar to the those of the receiver side of FIG. 1A, and the description of these components is not repeated.

Receiver side 1508 includes a chip stream analysis section 1510 to receive the decoded chip stream from decoder 130 and compare the chip stream with the PRSs Ra 114a and Rb 114b. The chip stream analysis section 1510 may perform synchronization of the received chip stream, for example, using a sliding correlator, as described previously. The chip stream analysis section 1510 may also determine which PRS Ra 114a or Rb 114b most closely matches a sequence of N_{c} chips (where N_{c} is the length of the PRSs) and so recover the corresponding key bit as recovered key 1514. The chip stream analysis section 1510 may also compare the N_{c} bits of the chip stream received from the decoder 130 with the most closely matching PRS to determine a chip error rate. The chip error rate may be reported to interception determination section 1512. The interception determination section 1512 may determine whether or not the chip error rate reported by the chip stream analysis section 1510 is indicative of a potential interception of the link. The determination performed by the interception determination section 1512 may be based on the chip error rate exceeding a predetermined threshold. In some examples, the determination may be based on a plurality of chip error rates reported by the chip stream analysis section 1510, such as more than a predetermined number of consecutive key bits having a chip error rate above a threshold. In some examples, the interception determination section 1512 makes the determination based on a machine learning model to distinguish between a potential interception and other sources of increased noise on the link.

In response to a determination that there is a potential interception of the link, the interception determination section 1512 may respond by performing one or more of the following:
Discarding the key 116 that is being received, or otherwise indicating that the recovered key 1514 is potentially compromised, e.g. such that the recovered key 1514 is not used.
Reporting 1516 the potential interception to the transmitter side 1506.
Providing an alert or indication to a user.

In some examples, the interception report 1516 may be sent continuously from the receiver side 1508 to the transmitter side 1506, providing an indication of negative interception determinations, as well as positive determinations. In some examples, the interception report 1516 is sent only when a potential interception has been detected. The interception report 1516 may be sent over any communication channel, and may be an open channel (e.g. encryption is not needed for the interception report 1516).

The transmitter side 1506 may respond to an indication of a potential interception by performing one or more of:
Stopping the transmission.
Providing an alert or indication to a user.

FIG. 16 shows a system 1600 according to some examples. Elements of system 1600 that are similar to those of the system 1500 of FIG. 15 have the same reference signs, and their descriptions are not repeated.

The receiver side 1508 of system 1600 does not include interception determination section 1512. Instead, the chip stream analysis section 1510 may provide a BER report 1604 to interception determination section 1602 located on the transmitter side 1506. The BER report 1604 may provide information indicative of the chip error rate currently determined by the chip stream analysis section 1510. In some examples, the chip error rate may be reported continually to the interception determination section 1602. The BER report 1604 may be sent over any communication channel, and may be an open channel.

The interception determination section 1602 may determine whether or not the chip error rate reported by the chip stream analysis section 1510 is indicative of a potential interception of the link. The determination by the interception determination section 1602 may be carried out in a similar manner to the determination performed by interception determination section 1512.

The interception determination section 1602 may respond to a detection of a potential interception by performing one or more of the following:
Stopping the transmission.
Providing an alert or indication to a user.
Reporting the potential interception to the receiver side 1508.

Reporting the potential interception to the receiver side 1508 may be performed via any channel, and may be via an open channel. In response to an indication of potential interception from the transmitter side 1506, the receiver side 1508 may, for example, discard the current recovered key 1514, alert a user, etc.

In some examples, the transmitter side 1506 may include interception determination section 1602 and the receiver side 1508 may include interception determination section 1512. In that case, each side may independently carry out an interception determination (using the same or different methods). The chip stream analysis section 1510 may provide BER report 1604 to the transmitter side 1506 in order to allow the determination to be performed by the transmitter side 1506.

In some communications systems, feedback on signal quality may be used to adjust the signal (e.g. Power or bandwidth) in order to maintain a particular signal quality, data rate, quality of service, etc. However, link stabilization techniques of this type are not used according to some examples. An interceptor 106 will cause a reduction of SNR and an increase in BER, as described above. Link stabilization techniques may respond to this by increasing the transmission power, or taking other steps to improve the channel quality. However, measures such as increasing the transmission power, may provide more power for the interceptor 106, improving the interceptor's SNR. Further such link stabilization measures may complicate or prevent detection of an interceptor 106. In some examples link stabilization may be used, for example where a change in signal quality is determined to be due to effects other than interception.

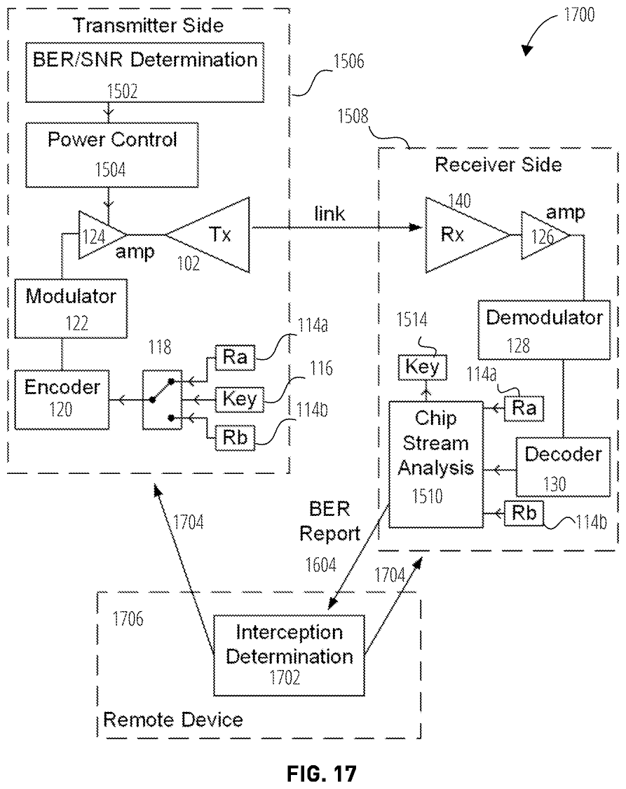

FIG. 17 shows another system 1700 according to an embodiment. Elements that are the same or similar to preceding figures have the same number, and are not described again in detail.

In this example, the chip stream analysis section 1510 provides BER report 1604 to a remote device 1706 that is distinct from both the transmitter side 1506 and receiver side 1508. The remote device 1706 may include interception determination section 1702. The interception determination section 1702 determines whether or not the BER report 1604 is indicative of a potential interception. This may be performed in a similar manner to the interception determination section 1512 and interception determination section 1602 of FIG. 15 and FIG. 16, respectively. The interception determination section 1702 may provide an interception report 1704 to the transmitter side 1506 and/or the receiver side 1508. The transmitter side 1506 and/or the receiver side 1508 may respond to a report of a potential interception as described previously, for example in relation to FIG. 15 and FIG. 16.

Various components shown in FIG. 15 to FIG. 17 may be implemented in software, hardware, firmware, etc., or some combination of these.

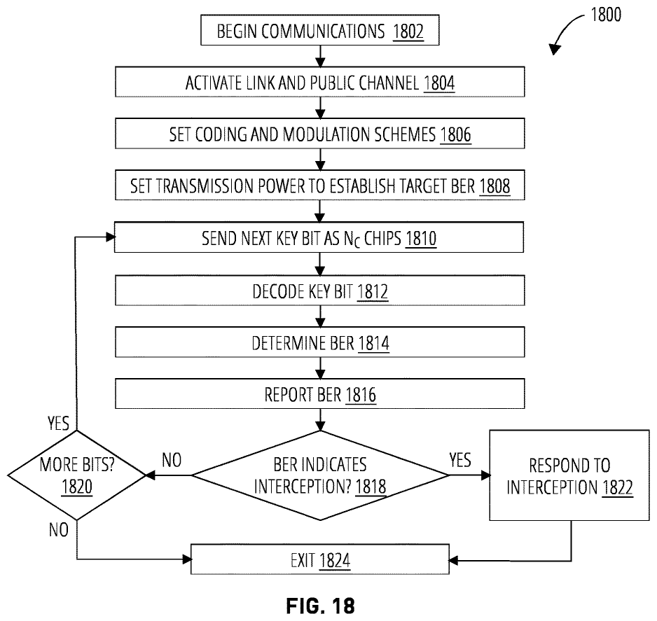

FIG. 18 shows an example method 1800 that may be performed in systems according to some examples, such as the systems in FIG. 15 to FIG. 17. The method 1800 begins at 1802 when it is determined that communication should be commenced. The link 104 is activated at 1804, along with a public channel if one is to be used. The public channel may be used for interception report 1516, BER report 1604, etc. The activation 1804 of the link and channel may be performed by transmitter side 1506, the receiver side 1508 or both acting together.

The coding and modulation schemes to be used, if any, may be set at 1806. These may be pre-set for the link (e.g. at initialisation of the system), or may be selected from a predetermined set of alternatives. At 1808, the transmission power may be set. The transmission power may have a preset value for the link. The transmission power may be set based on the modulation and coding scheme choices in 1806. Parameters such as target BER, number of chips per bit, etc. may also be set based on the selected modulation and coding scheme choices in 1806. The coding and modulation scheme, and the transmission power may be set by the transmitter side 1506. However, in some examples, this may be performed by the receiver side 1508 and communicated to the transmitter side 1506, or may be performed by the receiver side 1508 and transmitter side 1506 acting in combination.

At 1810 the transmitter 102 sends a key bit as a chip stream of N_{c} chips, modulated and encoded in accordance with the schemes selected at 1806, and with a transmission power corresponding with the power set at 1808. The receiver 140 receives the transmission and performs any necessary demodulation and decoding to obtain the chip stream. The chip stream is then compared with the PRSs used to represent the key bit at 1812 to obtain the bit of the decoded, or recovered, key 1514. This may be based on a determination of the PRS corresponding most closely with the recovered key bit.

At 1814 the receiver side 1508 determined the BER of the key bit based on a comparison of the N_{c} chips of the recovered key bit and the PRS corresponding most closely with the recovered key bit.

The receiver side 1508 may report the determined BER at 1816. The report may be provided to an element of the receiver side 1508, an element of the transmitter side 1506, a remote device 1706, or some combination of these.

The reported BER may be used, at 1818 to determine whether a potential interception has been detected. This determination 1818 may be performed by the receiver side 1508, the transmitter side 1506 or a remote device 1706. Where no potential interception as been detected, the method continues to 1820, and if further key bits remain to be processed, the next key bit is sent at 1810. If all key bits have been received, the method concludes as 1824.

Where an interception is detected at 1820, a suitable response to the detection is performed at 1822. As described previously, the response may include terminating the transmission, notifying other elements of the system, alerting a user, discarding the received key bits, etc.

FIG. 19 schematically shows a plot of BER with SNR and the corresponding ∂(BER)/∂(SNR) plot, similar to those shown in FIG. 2 and FIG. 3. The transmission power may be set in 1808 of method 1800 based on properties of one or both of these plots. For example, SNR_{crit} may be determined, and this value may be used as the target SNR, and the transmission power may then be set to achieve a target SNR at the receiver side 1508, under normal conditions of SNR_{crit}.

In some example, the full width at half maximum of ∂(BER)/∂(SNR) may be determined. Here, the maximum refers to the maximum absolute value of ∂(BER)/∂(SNR)′ shown as Bₘ/2 in FIG. 19. This could also be described as the full width at half maximum of −∂(BER)/∂(SNR) The transmission power may then be set to achieve a target SNR at the receiver side 1508, under normal conditions, of SNR_{crit}+w.

In some examples, SNR_{crit}+w may be selected as an upper value for SNR, and the target SNR may be set below the upper value.

In some examples, it may be acceptable to use a target SNR less than SNR_{crit}. In that case, the target SNR may be chosen as SNR_{crit}-w, between SNR_{crit}-w and SNR_{crit}+w, between SNR_{crit}−w and SNR_{crit}, etc., depending, for example, on the properties of the link.

The target SNR may be based on other parameters, instead of the full width at half maximum of ∂(BER)/∂(SNR) For example, the half width at half maximum, or half of the full width at half maximum.

In some examples values of one or more of SNR_{crit}, w, etc. may be calculated as part of the process of setting the target power and/or BER. In some examples, the target power and/or BER may be set without explicitly calculating SNR_{crit}, etc.

In some examples, the target SNR and/or transmission power may be selected empirically, e.g. by iteratively varying the signal power during initialisation of the system to determine values to be used.

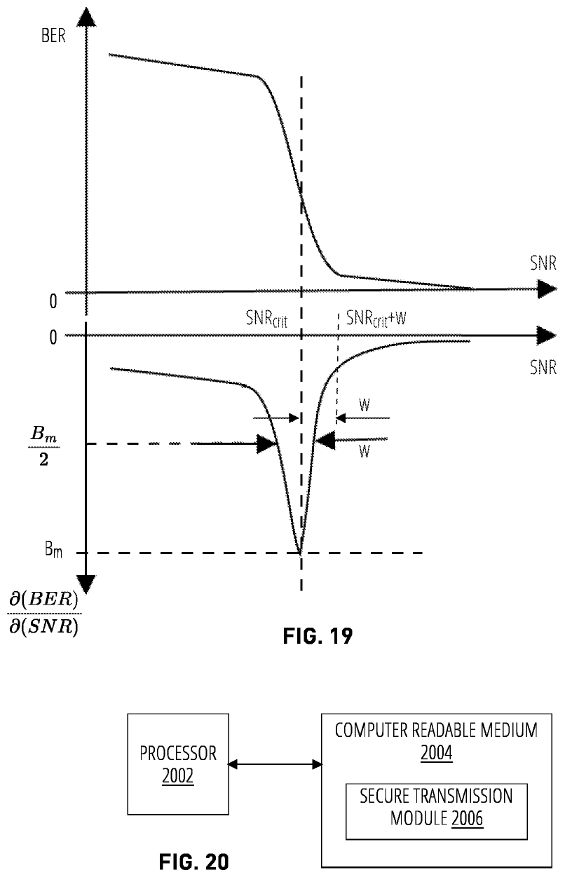

FIG. 20 shows an example of a computer-readable storage medium 2004 coupled to at least one processor 2002. The computer-readable medium 2004 can be any medium that can contain, store, or maintain programs and data for use by or in connection with an instruction execution system. The medium may be a memory of a computing device, arranged to store instructions for execution by a processor of the computing device.

In FIG. 20 the computer-readable storage medium comprises module 2006 (e.g. program code). The module 2006 may cause the processor 2002 to perform a method corresponding an example described herein. For example, the module 2006 may cause the Processor 2002 to perform the method 1000 of FIG. 10 or the method 1200 of FIG. 12. In other examples, the module 2006 may cause the processor 2002 to perform other operations of the examples described herein.

Comparison with QKD Systems

Experimental free space optical QKD systems are described in S.-K. Liao, et al., “Long-distance free-space quantum key distribution in daylight towards inter-satellite communication,” Nature Photonics, vol. 11, no. 8, pp. 509-513, August 2017 and W.-Y. Liu, et al., “Experimental free-space quantum key distribution with efficient error correction,” Opt. Express, vol. 25, no. 10, pp. 10 716-10 723, May 2017. Table I shows the performance of these QKD systems. The table also shows the parameters for an example of the system described herein, where the following assumptions and observations have been made:
1. SNR. The SNR is set to 0.457, which is the critical SNR for an LDPC code with rate 0.25 (as described in relation to FIG. 3).
2. BER. An SNR of 0.457 corresponds to a BER of 0.119 for the LDPC code with rate 0.25 (see FIG. 2).
3. Noise Bandwidth. This is assumed to be 160 MHz to be consistent with that of cutting edge microwave point-to-point communications products. This bandwidth is likely to increase as technology evolves, for example for equipment operating in the millimeter wave bands.
4. Spreading factor. This is the number of chips in the PRS that make up a single key bit and is termed N_{c}. Since the BER is approximately 10% in this example, N_{c} is chosen to be greater than 20. The larger N_{c} is, the higher the confidence of determining BER accurately at the receiver. However the larger N_{c} becomes, the lower the key rate will be. This example uses N_{c}=200.

The key rate may be determined using the Shannon capacity theorem provided in equation 1, as follows.

$$C = 160 \times {10}^{6} {log}_{2} ( 1 + 0.457 ) {R}_{c} / {N}_{c} \qquad ( 7 )$$

Hence, using the parameters above gives C=108 kb/s which is substantially greater than the two other examples as shown in the table. Furthermore, whilst the key error rate is higher than the other two examples, a higher SNR can be selected. A very slight increase in SNR by 0.1 to 0.557 results in a BER of less than 3×10⁻⁶. Using this value would result in a probability of zero errors p_{zero}>0.999. This would make this link more efficient and also reduce the false positive rate, however the trade-off would be a slight reduction in sensitivity to detecting interception.

TABLE 1

| | | | | | | | Spectral |
|---|---|---|---|---|---|---|---|
| | | Noise | | | | Key Error | Efficiency |
| System | FEC | Bandwidth | | Key Rate | | Rate | b/s/Hz |
| QKD1 | LDPC | 6 × 10⁶ | THz | 20-400 | b/s * | 0.039 and | 3.3 × 10⁻¹⁸ to |
| (Liao et al.) | | | | | | 0.0918 ** | 6.7 × 10⁻¹⁷ |
| QKD2 | Turbo | 6 × 10⁴ | THz | 500 | b/s | 0.034 | 5 × 10⁻¹⁵ |
| (Liu, et at.) | | | | | | | |
| Present system | LDPC | 160 | MHz | 108.6 | kb/s | 0.119 | 6.8 × 10⁻⁴ |
| (SNR = 0.457) | | | | | | | |
| Present system | LDPC | 160 | MHz | 128.6 | kb/s | 3 × 10⁻⁶ | 8 × 10⁻⁴ |
| (SNR = 0.53) | | | | | | | |

* depending on atmospheric variations
** for each of 2 states

It is clear from table I that the present system with SNR=0.557 provides the highest key rate, lowest key error rate and highest spectral efficiency of the candidate systems.

Examples described herein take advantage of the Shannon Capacity theorem, which describes the limit of data capacity for a conventional data transfer channel. Unlike QKD, it does not require the manipulation of single or even a small number of photons, making it suitable for radio frequency operation, thus allowing for enhanced security of communication links operating at frequencies below optical and where similar techniques have been highly challenging to implement due to the significantly reduced photon energy at these frequencies compared to optical frequencies. Embodiments herein can provide security against “man in the middle” and “standoff” attacks for links operating at radio frequencies in a similar manner to QKD at optical frequencies, which has been a long standing challenge. Examples herein do not rely on secret spreading codes that may be compromised by an adversary, nor on adding artificial noise to obscure the data, however both or either of these techniques may be used in cooperation with the disclosed examples. The described examples do not rely on backscatter created by the presence of an eavesdropping device, and instead uses the signal received by the legitimate receiver 140 to detect the eavesdropping device. Embodiments according to the disclosed arrangements may be far more sensitive by exploiting the non-linearity of the BER versus SNR curve when operating close to the Shannon limit.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. A method of monitoring a transmission, the method comprising:
obtaining one or more values of bit error rate (BER) of the transmission received at a receiver; and
determining that the transmission has been intercepted based on a deviation of the obtained bit error rate value from an expected bit error rate value.

2. The method of claim 1, wherein the expected BER corresponds with the transmission having a first signal to noise ratio (SNR) at the receiver, wherein
a critical value, SNR_{crit}, is a SNR value at a minimum in d(BER)/d(SNR), where BER is the bit error rate at the receiver, and
a difference between the first SNR and SNR_{crit} is less than a full width at half maximum of d(BER)/d(SNR) with SNR.

3. A method for transmitting a transmission to a receiver, the method comprising:
setting a parameter of the transmission such that the transmission is to have a first signal to noise ratio (SNR) at the receiver; and
causing the transmission to be transmitted according to the set parameter, wherein
a critical value, SNR_{crit}, is a SNR value at a minimum in d(BER)/d(SNR) with SNR, where BER is the bit error rate at the receiver, and
a difference between the first SNR and a critical value is less than a full width at half maximum of d(BER)/d(SNR) with SNR.

4. The method of claim 3, the method further comprising:
obtaining one or more values of bit error rate (BER) of the signal received at the receiver; and
determining that the transmission has been intercepted based on a deviation of the obtained BER values from expected BER values.

5. The method of claim 2, wherein the method further comprises:
at least one of:
determining the critical value, SNR_{crit},
determining a SNR corresponding with a negative peak in d(BER)/d(SNR), or
determining an upper SNR value, such that a difference between the upper SNR value and the critical value is less than or equal to the full width at half maximum, and the parameter is set such that the first SNR is less than the upper SNR value.

6. The method of claim 3, wherein the parameter of the transmission is such that the transmission is to have the first signal to noise ratio at the receiver when a power of the signal at the receiver is: at least 40% of the power of the transmission, or at least 50% of the power of the transmission, or at least 60% of the power of the transmission.

7. The method of claim 1, wherein the transmission is encoded using one of Forward Error Correction (FEC), Low Density Parity Check (LDPC) codes, Bose-Chaudhuri-Hocquenghem (BCH) codes, Polar codes, Turbo codes, or Reed Solomon codes.

8. The method of claim 1, wherein the transmission is via a point-to-point link, a microwave beam, a beamformed radio link, a line of sight radio link, an optical beam, a laser, an acoustic link, near-field communication, a wired link, a waveguide, or an optical fibre.

9. The method of claim 1, wherein at least one of:
the transmission is monitored without quantum level measurements;
the transmission is via a communication link that uses classical methods;
the transmission is via a memory-less channel; or
the transmission uses directional modulation.

10. The method of claim 1, wherein the transmission includes one or more pseudorandom sequence (PRS) selected from a set of two pseudorandom sequences, each pseudorandom sequence of the set of pseudorandom sequences representing a message bit.

11. The method of claim 10, wherein the two pseudorandom sequences are not mutually orthogonal.

12. The method of claim 10, wherein each pseudorandom sequence includes a plurality of chips, each chip being a binary digit, and
the BER is determined by determining which pseudorandom sequence of the set is most similar to the pseudorandom sequence as received at the receiver and performing a chip-wise comparison between the pseudorandom sequence as received and the determined pseudorandom sequence of the set.

13. The method of claim 10, wherein the method further comprises, determining that a pseudorandom sequence update condition has been met and, in response, updating the set of pseudorandom sequences.

14. The method of claim 1, wherein the transmission carries data indicative of an encryption key.

15. (canceled)

16. A non-transitory computer-readable storage medium, the computer-readable storage medium including instructions that when executed by a computing device, cause the computing device to carry out the method of claim 1.

17. A computing apparatus comprising:
a processor; and
a memory storing instructions that, when executed by the processor, configure the apparatus to carry out the method of claim 1.

18. A transmitter device comprising:
the computing apparatus of claim 17, and
a transmitter to transmit the transmission.

19. A detection device for use in detecting interception of a transmission, the device comprising:
the computing apparatus of claim 17, and
an output to output a report to indicate that interception of the transmission has been detected.

20. A data transmission system, the system comprising:
a transmitter;
a receiver; and
the detection device of claim 19.

21. The data transmission system of claim 20, wherein the detection device is:
included in the transmitter,
included in the receiver, or
external to each of the transmitter and the receiver.
